(19) United States
(12) Patent Application Publication
(10) Pub. No.: US 2022/0383395 A1
(43) Pub. Date: Dec. 1, 2022

(54) MULTI-SERVICE PROVIDER INTERACTIVE SUPPORT AND COMMUNICATION INTERFACE

(71) Applicant: Corrina Young, Morrisville, NC (US)

(72) Inventor: Corrina Young, Morrisville, NC (US)

(21) Appl. No.: 17/331,313

(22) Filed: May 26, 2021

(51) Int. Cl. G06Q 30/06; G06F 9/451

(52) U.S. Cl. CPC G06Q 30/0643; G06F 9/451

(57) ABSTRACT

Provided herein are systems, methods and computer program product for operating a multi-service provider interactive support and communication interface of a multi-service provider interactive support and communication system. A method is provided to receive a dynamic service request and to output, to a computer interface, the multi-service provider interactive support and communication interface, the multi-service provider interactive support and communication interface comprising a plurality of services based on the consumer user identifier and the consumer user data, wherein each service identifies a type of service, a price of the service, a regional average price of the service, and a virtual try-on interface element, wherein the virtual try-on interface element is configured to depict a transformation to the consumer user's body according to the type of service.

### BACKGROUND

Consumers often find themselves in need of services by geolocation and in real-time. Applicant has identified a number of deficiencies and problems associated with conventional methods of internet searching for services and service providers. Through applied effort, ingenuity, and innovation, many of these identified problems have been solved by developing solutions that are included in embodiments of the present invention, many examples of which are described in detail herein.

### BRIEF SUMMARY

In general, embodiments of the present invention provided herein include methods, apparatus, and computer program products for facilitating a multi-service provider interactive support and communication interface.

Example embodiments include an apparatus for operating a multi-service provider interactive support and communication interface of a multi-service provider interactive support and communication system, wherein the apparatus comprises at least one processor, and at least one memory having computer coded instructions therein, with the computer instructions configured to, when executed by the processor, cause the apparatus to receive a dynamic service request, the dynamic service request comprising a consumer user account identifier and consumer user data. The apparatus is further configured to output, to a computer interface, the multi-service provider interactive support and communication interface, the multi-service provider interactive support and communication interface comprising a plurality of services based on the consumer user identifier and the consumer user data, wherein each service identifies a type of service, a price of the service, a regional average price of the service, and a virtual try-on interface element, wherein the virtual try-on interface element is configured to depict a transformation to the consumer user's body according to the type of service.

Embodiments may also include a computer-implemented method for operating a multi-service provider interactive support and communication interface of a multi-service provider interactive support and communication system, the computer-implemented method comprising receiving a dynamic service request, the dynamic service request comprising a consumer user account identifier and consumer user data, and outputting, to a computer interface, the multi-service provider interactive support and communication interface, the multi-service provider interactive support and communication interface comprising a plurality of services based on the consumer user identifier and the consumer user data, wherein each service identifies a type of service, a price of the service, a regional average price of the service, and a virtual try-on interface element, wherein the virtual try-on interface element is configured to depict a transformation to the consumer user's body according to the type of service.

Embodiments also include a computer program product, stored on a computer readable medium, comprising instructions that when executed on one or more computers cause the one or more computers to perform operations comprising receiving a dynamic service request, the dynamic service request comprising a consumer user account identifier and consumer user data, and outputting, to a computer interface, the multi-service provider interactive support and communication interface, the multi-service provider interactive support and communication interface comprising a plurality of services based on the consumer user identifier and the consumer user data, wherein each service identifies a type of service, a price of the service, a regional average price of the service, and a virtual try-on interface element, wherein the virtual try-on interface element is configured to depict a transformation to the consumer user's body according to the type of service.

### BRIEF DESCRIPTION OF THE FIGURES

Having thus described embodiments of the invention in general terms, reference will now be made to the accompanying drawings, which are not necessarily drawn to scale, and wherein:

FIG. 1 illustrates an example multi-service provider interactive support and communication system configured in accordance with some embodiments discussed herein;

FIG. 2 illustrates a schematic block diagram of example circuitry configured for a client device, such as a consumer user device, service provider user device, and/or a multi-service provider interactive support and communication system, in accordance with some embodiments discussed herein;

FIG. 3 illustrates an example operation sequence diagram illustrating operations performed by devices of a service support system configured in accordance with some embodiments discussed herein;

FIG. 4 illustrates an example operation sequence diagram illustrating operations performed by devices of a service support system configured in accordance with some embodiments discussed herein;

FIG. 5 illustrates an example operation sequence diagram illustrating operations performed by devices of a service support system configured in accordance with some embodiments discussed herein;

FIGS. 6-16 illustrate example multi-service provider interactive support and communication interfaces in accordance with some embodiments discussed herein; and

FIG. 17 illustrates a flow diagram of example operations performed by the multi-application interactive support and communication system in accordance with some embodiments discussed herein.

### DETAILED DESCRIPTION

Some embodiments of the present invention will now be described more fully hereinafter with reference to the accompanying drawings, in which some, but not all embodiments of the inventions are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

### Terms

As used herein, the term “multi-service provider interactive support and communication interface” refers to a virtual communication environment (e.g., a graphic user interface) that is configured to facilitate consumer user interaction with a multi-service provider interactive support and communication system (defined below). The multi-service provider interactive support and communication interface includes a plurality of services, wherein each service includes a virtual try-on interface element (defined below). In some embodiments, the multi-service provider interactive support and communication interface includes an augmented reality environment interface (defined below). The multi-service provider interactive support and communication interface is configured to facilitate consumer user communication with one or more service providers and a plurality of services via the multi-service provider interactive support and communication system.

The term “multi-service provider interactive support and communication system” refers to a communications software platform and associated hardware that is configured to support and maintain a multi-service provider interactive support and communication interfaces. The multi-service provider interactive support and communication system manages communications between consumer users and service provider users. In various embodiments, the multi-service provider interactive support and communication system is configured to provide consumer users with real-time data from various services offered by various service providers to assist the consumer user with service decisions (e.g., choosing the best service offering) based on analytics and other data derived from consumer user data. To this end, the multi-service provider interactive support and communication system receives a dynamic service request (defined below) from a consumer user device and facilitates identification, through consumer user engagement, of a plurality of services for the dynamic service request.

The term “multi-service provider interactive support and communication application” refers to a stand-alone or desktop application designed and written to leverage the operating system on the multi-service provider interactive support and communication system. In embodiments a mobile device, such as a smart phone or tablet, may execute an “app” such as the multi-service provider interactive support and communication application to interact with the multi-service provider interactive support and communication system. Such apps are typically designed to execute on mobile devices, such as tablets or smartphones. For example, an app may be provided that executes on mobile device operating systems such as iOS®, Android®, or Windows®. Alternatively, the multi-service provider interactive support and communication application can be designed and written as a module or extension to function within another service application already present on the multi-service provider interactive support and communication system. For example, a Java™ Applet or Active X component designed to execute in a web browser such as Firefox™, Chrome™, or Internet Explorer™. The multi-service provider interactive support and communication application runs locally on the multi-service provider interactive support and communication system in order to execute functionality. The multi-service provider interactive support and communication application can retrieve a plurality of consumer user data elements in order to populate the plurality of multi-service provider interactive support and communication interfaces. The result is a multi-service user interface, assembled by the multi-service provider interactive support and communication application, using data provided by a plurality of service providers to populate the plurality of multi-service provider interactive support and communication interfaces.

The term “dynamic service request” refers to an electronic information package transmitted by a consumer user device to a multi-service provider interactive support and communication system and which is used, by the multi-service provider interactive support and communication system, to update a multi-service provider interactive support and communication interface. The dynamic service request comprises a consumer user account identifier (defined below) and consumer user data (defined below).

The term “consumer user account identifier” refers to a unique identifier that is used by the multi-service provider interactive support and communication system to identify a particular consumer user account and any data associated with such consumer user account (e.g., a consumer user account profile, consumer user device data, consumer user transaction history, consumer user application history, etc.). For example, and without limitation, a consumer user account identifier may include a unique identifier, an internet protocol (IP) address, a media access control (MAC) address, a user identifier, and the like.

The term “consumer user data” refers to any data, metadata, records, error codes, service request descriptions, and the like that indicate a desired service associated with a consumer user account to the multi-service provider interactive support and communication system. Such desired services may include, without limitation, a selected service data request, a service inquiry request, a service recommendation, a service exchange request, a service cancellation request, a service ordering assistance request, a refund request, a system error report, and the like.

The term “virtual try-on interface element” refers to a portion of the multi-service provider interactive support and communication interface that is configured to support consumer user interaction with a plurality of service offerings. The virtual try-on interface element is configured to depict a transformation to the consumer user's body according to the type of service selected. Consumer user engagement of one of the plurality of services causes the multi-service provider interactive support and communication system to display a virtual try-on interface element of the selected service. In this way, the virtual try-on interface element is configured to overlay image data associated with the type of service onto a real-time image of the consumer user's body. In one embodiment, a virtual try-on interface element is an augmented reality overlay reflective of a generated tattoo over the real-time image of the consumer user's body. In other embodiments, a virtual try-on interface element is may take other augmented realty content types (e.g., makeup, clothing, hair styles, etc.).

The term “service provider” refers to a service provider representative, service advisor, or the like that engages or otherwise interacts with the multi-service provider interactive support and communication system through the multi-service provider interactive support and communication interface to showcase available services provided by the service provider and help resolve consumer user issues.

The term “augmented reality environment interface” refers to a portion of the multi-service provider interactive support and communication interface that is configured to visually and virtually facilitate a scavenger hunt-type game in which clues are provided to the consumer user. Such clues hint at the location of a virtual object (e.g., hidden “prize”). To this end, the augmented reality environment interface is used by the service provider to award prizes to consumer users. This is accomplished interactively between the multi-service provider interactive support and communication application and the consumer user. The multi-service provider interactive support and communication application is configured to require the consumer user to be at a predetermined location. Once the user is determined to be at a predetermined location, the multi-service provider interactive support and communication application then displays a virtual object overlaid onto the image data of the consumer user's environment at the predetermined location. The virtual object representative of a reward or coupon (e.g., service discount, free service voucher, free tchotchke, etc.).

The terms “data,” “content,” “information” and similar terms may be used interchangeably to refer to data capable of being captured, transmitted, received, displayed and/or stored in accordance with various example embodiments. Thus, use of any such terms should not be taken to limit the spirit and scope of the disclosure. Further, where a computing device is described herein to receive data from another computing device, it will be appreciated that the data may be received directly from the another computing device or may be received indirectly via one or more intermediary computing devices, such as, for example, one or more servers, relays, routers, network access points, base stations, and/or the like, sometimes referred to herein as a “network.” Similarly, where a computing device is described herein to send data to another computing device, it will be appreciated that the data may be sent directly to another computing device or may be sent indirectly via one or more intermediary computing devices, such as, for example, one or more servers, relays, routers, network access points, base stations, and/or the like.

The terms “computer-readable storage medium” or “non-transitory memory medium” refers to a non-transitory, physical or tangible storage medium (e.g., volatile or non-volatile memory), which may be differentiated from a “computer-readable transmission medium,” which refers to an electromagnetic signal.

### Overview

Various embodiments of the invention are directed to a multi-service provider interactive support and communication interface (referred to herein simply as “MSPISC interface”) that is configured to be adaptive, intuitive, and to allow a consumer to browse and purchase services provided by service providers. The MSPISC interface is also configured to allow service providers to showcase, market, or advertise their service offerings, as well as connect with their consumers to offer deals, giveaways, or promotions. The MSPISC interface may be used as part of a standalone service, application, or device or it may be applied as a layer atop an existing service application or device. The MSPISC interface facilitates the execution of service scheduling, service management, and marketing tools.

For example, the MSPISC interface may be configured to display a plurality of services based on the consumer. In one example, each service may identify a type of service, a price of the service, a regional average price of the service, and a virtual try-on interface element. The virtual try-on interface element is configured to depict a transformation to the consumer user's body according to the type of service. As will be discussed in greater detail below, the MSPISC interface is further configured to provide service providers with real-time data to assist the service provider with marketing and sales decisions based on analytics. In another example embodiment, the MSPISC interface may facilitate automatically scheduling service jobs. The MSPISC interface is configured to be used by a service provider and may be tailored to suit an individual service provider's preferences, preferred configuration, or specific data needs.

The MSPISC interface depicted in the figures appended to the present application is configured for consumer users and service provider users associated with beauty and wellness services via an e-commerce platform. However, the inventive concepts herein described are not limited to an e-commerce platform and may be applied to any other type of multi-user system. For example, in other embodiments, the MSPISC interface may facilitate connecting users with in-home caregivers, tutors, and the like. One of ordinary skill in the art will appreciate that the MSPISC interface related concepts discussed herein, may be applied in a variety of industries.

### Exemplary Architecture

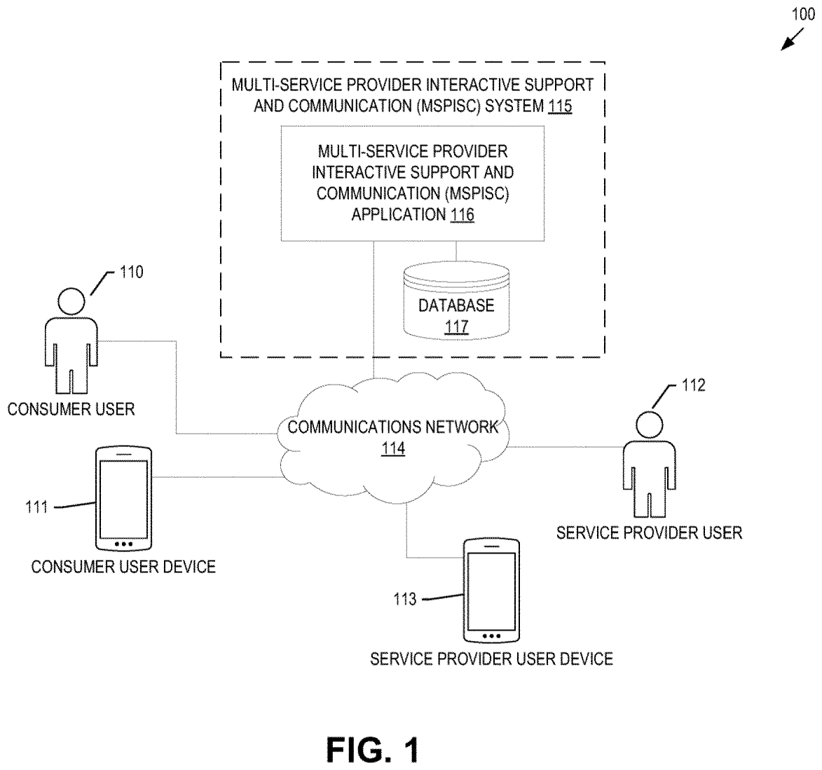

FIG. 1 shows a system 100 including an example network architecture for a multi-service provider interactive support and communication (MSPISC) system 115, which includes one or more devices and sub-systems that are configured to implement some embodiments discussed herein. Consumer users may access MSPISC system 115 via a communications network 114 using consumer user devices (i.e., client devices) 111. Service provider users access the MSPISC system 115 using service provider user devices 113. The MSPISC system 115 comprises a MSPISC application 116 that is disposed in communication with a database 117.

Typically, consumer users and service provider users using consumer user device 111 and service provider user device 113 will access and communicate with database 117 through communications network 114. Communications network 114 may include any wired or wireless communication network including, for example, a wired or wireless local area network (LAN), personal area network (PAN), metropolitan area network (MAN), wide area network (WAN), or the like, as well as any hardware, software and/or firmware required to implement it (such as, e.g., network routers, etc.). For example, communications network 114 may include a cellular telephone, an 802.11, 802.16, 802.20, and/or WiMAX network. Further, the communications network 114 may include a public network, such as the Internet, a private network, such as an intranet, or combinations thereof, and may utilize a variety of networking protocols now available or later developed including, but not limited to TCP/IP based networking protocols. For instance, the networking protocol may be customized to suit the needs of the group-based communication system. In some embodiments, the protocol is a custom protocol of JSON (JavaScript Object Notation) objects sent via a Web Socket channel. In some embodiments, the protocol is JSON over RPC (“remote procedural call”), JSON over REST(“Representational State Transfer”)/HTTP (“HyperText Transfer Protocol”), and the like.

The database 117 may be embodied as a data storage device such as a Network Attached Storage (NAS) device or devices, or as a separate database server or servers. The database 117 comprises information accessed and stored by MSPISC system 115 to facilitate the operations of the MSPISC application 116. For example, the database 117 may include, without limitation, consumer user data and service provider user data. In another example embodiment, database 117 may also include services data.

The consumer user devices 111 and the service provider user devices 113 may be any computing device as defined herein. Electronic data received by the MSPISC system 115 from the consumer user devices 111 and service provider user devices 113 may be provided in various forms and via various methods. The consumer user devices 111 and the service provider user devices 113 may include desktop computers, laptop computers, smartphones, netbooks, tablet computers, wearables, and the like.

Additionally or alternatively, the consumer user devices 111 and service provider user devices 113 may interact with the MSPISC system 115 via a web browser. As yet another example, the consumer user devices 111 and service provider user devices 113 may include various hardware or firmware modules designed to interface with the MSPISC system 115.

In an example embodiment, where the consumer user devices 111 and service provider user devices 113 are mobile devices, such as a smart phone or tablet, the consumer user devices 111 and service provider user devices 113 may execute an “app” to interact with the MSPISC application 116. Such apps are typically designed to execute on mobile devices, such as tablets or smartphones. For example, an app may be provided that executes on mobile device operating systems such as Apple Inc.'s iOS®, Google Inc.'s Android®, or Microsoft Inc.'s Windows 8®. In an example embodiment the app directs the consumer user and service provider user to MSPISC interface functionality, from which the consumer user and service provider user is able to browse and manage offered services. The MSPISC interface serves as a single point (e.g., one-stop) source for all service needs of the consumer user of the MSPISC application 116. The MSPISC interface also serves as a single point (e.g., one-stop) platform to manage all services offered by the service provider user of the MSPISC application 116. Through the MSPISC interface, the consumer user is provided with a plurality of virtual try-on interface elements to identify a preferred service. To this end, the MSPISC application 116 is configured to receive a real-time image of the consumer user's body and image data associated with the type of service and then, overlay, via the virtual try-on interface, the image data associated with the type of service onto the real-time image of the consumer user. As such, such technology enables service providers to personalize the consumer user experience and better meet the expectations of consumer users.

### Example Apparatus for Implementing Embodiments of the Present Disclosure

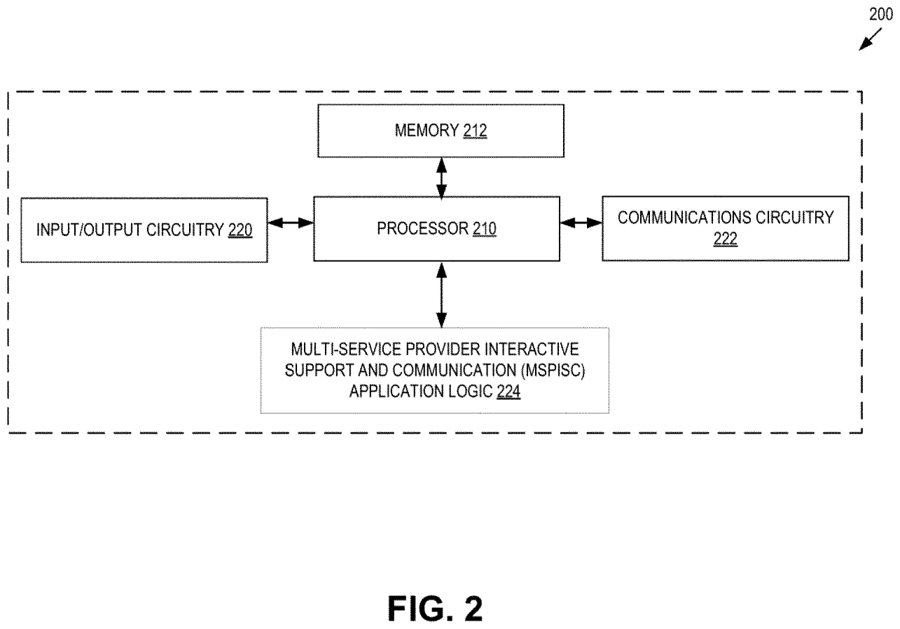

FIG. 2 shows a schematic block diagram of circuitry 200, some or all of which may be included in, for example, MSPISC application 116. Any of the aforementioned systems or devices may include the circuitry 200 and may be configured to, either independently or jointly with other devices in a communications network 114 perform the functions of the circuitry 200 described herein. As illustrated in FIG. 2, in accordance with some example embodiments, circuitry 200 may comprise various means, such as processor 210, a memory 212, input/output circuitry 220, communications circuitry 222, and MSPISC application logic 224. The circuitry 200 may be configured to execute the operations described herein. Although the components are described with respect to functional limitations, it should be understood that the particular implementations necessarily include the use of particular hardware. It should also be understood that certain of the components described herein may include similar or common hardware. For example, two sets of circuitry may both leverage use of the same processor, network interface, storage medium, or the like to perform their associated functions, such that duplicate hardware is not required for each set of circuitry. The use of the term “circuitry” as used herein with respect to components of the apparatus should therefore be understood to include particular hardware configured to perform the functions associated with the particular circuitry as described herein.

The term “circuitry” should be understood broadly to include hardware and, in some embodiments, software for configuring the hardware. For example, in some embodiments, “circuitry” may include processing circuitry, storage media, network interfaces, input/output devices, and the like. In some embodiments, other elements of the circuitry 200 may provide or supplement the functionality of particular circuitry. For example, the processor 210 may provide processing functionality, the memory 212 may provide storage functionality, the communications circuitry 222 may provide network interface functionality, and the like.

In some embodiments, the processor 210 (and/or co-processor or any other processing circuitry assisting or otherwise associated with the processor) may be in communication with the memory 212 via a bus for passing information among components of the apparatus. The memory 212 may be non-transitory and may include, for example, one or more volatile and/or non-volatile memories. In other words, for example, the memory may be an electronic storage device (e.g., a computer readable storage medium). The memory 212 may be configured to store information, data, content, applications, computer coded instructions, or the like, for enabling the circuitry 200 to carry out various functions in accordance with example embodiments of the present disclosure.

The processor 210 may be embodied in a number of different ways and may, for example, include one or more processing devices configured to perform independently. Additionally or alternatively, the processor may include one or more processors configured in tandem via a bus to enable independent execution of computer coded instructions, pipelining, and/or multithreading. The use of the term “processing circuitry” may be understood to include a single core processor, a multi-core processor, multiple processors internal to the apparatus, and/or remote or “cloud” processors.

In an example embodiment, the processor 210 is configured to execute computer coded instructions stored in the memory 212 or otherwise accessible to the processor. In various embodiments, the processor 210 is configured to execute computer coded instructions provided by MSPISC application logic 224.

Alternatively, or additionally, the processor may be configured to execute hard-coded functionality. As such, whether configured by hardware or software methods, or by a combination thereof, the processor may represent an entity (e.g., physically embodied in circuitry) capable of performing operations according to an embodiment of the present disclosure while configured accordingly. Alternatively, as another example, when the processor is embodied as an executor of software instructions, the computer coded instructions may specifically configure the processor to perform the algorithms and/or operations described herein when the computer coded instructions are executed.

In some embodiments, the circuitry 200 may include input/output circuitry 220 that may, in turn, be in communication with processor 210 to provide output to the user and, in some embodiments, to receive an indication of a user input. The input/output circuitry 220 may comprise a user interface and may include a display and may comprise a web user interface, a mobile application, a client device, a kiosk, or the like. In some embodiments, the input/output circuitry 220 may also include a keyboard, a mouse, a joystick, a touch screen, touch areas, soft keys, a microphone, a speaker, or other input/output mechanisms. The processor and/or user interface circuitry comprising the processor may be configured to control one or more functions of one or more user interface elements through computer program instructions (e.g., software and/or firmware) stored on a memory accessible to the processor (e.g., memory 212, and/or the like).

The communications circuitry 222 may be any means such as a device or circuitry embodied in either hardware or a combination of hardware and software that is configured to receive and/or transmit data from/to a network and/or any other device, circuitry, or module in communication with the circuitry 200. In this regard, the communications circuitry 222 may include, for example, a network interface for enabling communications with a wired or wireless communication network. For example, the communications circuitry 222 may include one or more network interface cards, antennae, buses, switches, routers, modems, and supporting hardware and/or software, or any other device suitable for enabling communications via a network. Additionally or alternatively, the communication interface may include the circuitry for interacting with the antenna(s) to cause transmission of signals via the antenna(s) or to handle receipt of signals received via the antenna(s).

In one example, the circuitry 200 may include a MSPISC application logic 224 configured to facilitate all functionality described herein associated with the MSPISC application 116. In different examples, the MSPISC application logic 224 may be implemented in hardware, software, firmware, and/or combinations thereof. In one embodiment, the consumer user device 111 and/or service provider user device 113 of FIG. 1 is configured with an installed MSPISC software application that is configured to communication with the MSPISC system 115 and thereby configured to render a MSPISC interface. In various embodiments, the MSPISC application logic 224 includes data and instructions that are executed by processor 210.

As described above and as will be appreciated based on this disclosure, embodiments of the present disclosure may be configured as computer implemented methods, mobile devices, backend network devices, and the like. Accordingly, embodiments may comprise various means including entirely of hardware or any combination of software and hardware. Furthermore, embodiments may take the form of a computer program product on at least one non-transitory computer-readable storage medium having computer-readable program instructions (e.g., computer software) embodied in the storage medium. Similarly, embodiments may take the form of a computer program code instructions stored on at least one non-transitory computer-readable storage medium. Any suitable computer-readable storage medium may be utilized including non-transitory hard disks, CD-ROMs, flash memory, optical storage devices, or magnetic storage devices.

As will be appreciated, any such computer program instructions and/or other type of code may be loaded onto a computer, processor or other programmable apparatus's circuitry to produce a machine, such that the computer, processor, or other programmable circuitry that execute the code on the machine creates the means for implementing various functions, including those described herein.

### Example Data Flows

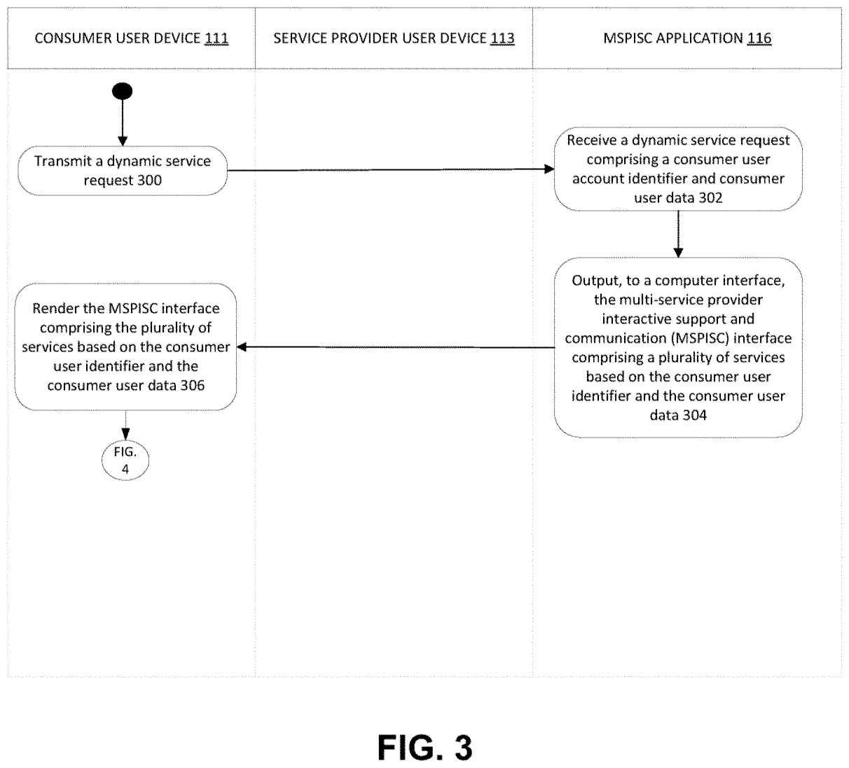

FIGS. 3, 4, and 5 illustrate various interactions between the following system components show in FIG. 1: consumer user device 111, service provider user device 113, and MSPISC application 116. Referring now to FIG. 3, the process illustrates example operations performed by a MSPISC application 116 for outputting to a MSPISC interface to a display interface (i.e., a graphical user interface) of consumer user device.

The process illustrated in FIG. 3 starts at step 300, where a consumer user device, for example consumer user device 111, transmits a dynamic service request to the MSPISC application 116. In 302, the MSPISC application 116 is configured to receive the dynamic service request comprising a consumer account identifier and consumer user data. The dynamic service request is used by the MSPISC application 116 to update a MSPISC interface.

In the depicted example, the dynamic service request comprises a consumer user account identifier and consumer user data (that are transmitted as an electronic information package) that are structured for receipt by the MSPISC application 116 of the MSPISC system 115. The MSPISC application 116 may manage a plurality of dynamic service requests from a plurality of consumer user devices 111. In one embodiment, the MSPISC application 116 is configured to identify recommended services based on at least the consumer user account identifier and/or the consumer user data. In one embodiment, the consumer user data includes a service identifier associated with a particular service that is of interest to the consumer user associated with the dynamic service request. The MSPISC application 116 may query database 117 for recommended services based on the consumer user account identifier, consumer user data, and/or service identifier.

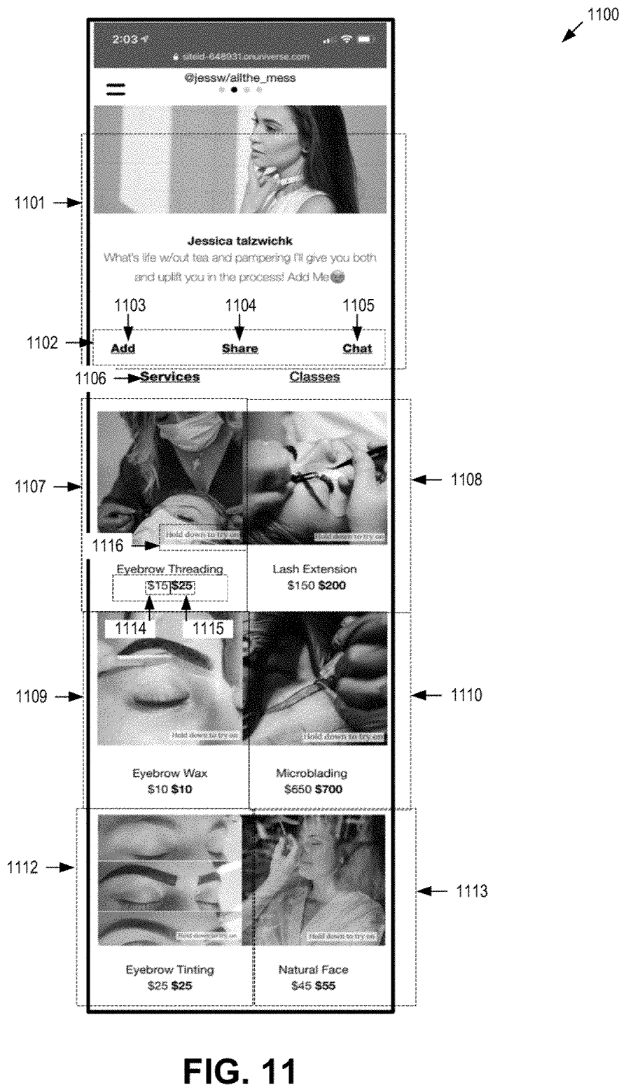

In step 304, the MSPISC application 116 is configured to output or update a MSPISC interface comprising a plurality of services based on the consumer user identifier and the consumer user data. An example of the MSPISC interface comprising a plurality of services is illustrated in FIG. 11 as display 1100. Each service of the depicted plurality of services identifies a type of service, a price of the service, a regional average price of the service, and a virtual try-on interface element. As discussed in greater detail below, consumer user engagement of one of the plurality of try-on interface elements causes the MSPISC system 115 to depict a transformation to the consumer user's body according to the type of service.

For example, FIG. 11 depicts a MSPISC interface display 1100 that displays a particular service provider 1101 having a plurality of service provider engagement elements 102 allowing the consumer user to add the service provider 1103, share the service provider 1104, and chat with the service provider 1105. In addition, the MSPISC interface display 1100 includes a listing of services 1107-1113 as displayed below the services container element 1106. FIG. 11 illustrates that for each of the plurality of services 1107-1113, the MSPISC application 116 is configured to output a price of the particular service 1114, a regional average price of the particular service 1115, and the try-on interface element 1116 associated with the particular service.

In determining the regional average price of the particular service, the MSPISC application 116 is configured to utilize a global positioning system (GPS) of the consumer device, or the like to identify the location of the consumer user in order to calculate an average price of the particular service based on present offers from nearby service providers based on the particular service.

Returning to FIG. 3, in step 306, the consumer user device 111 is configured to render the MSPISC interface comprising the plurality of services based on the consumer user identifier and the consumer user data. The MSPISC interface comprising the plurality of services is configured to facilitate consumer user interaction with multiple services offered by a plurality of service provider users, as discussed above.

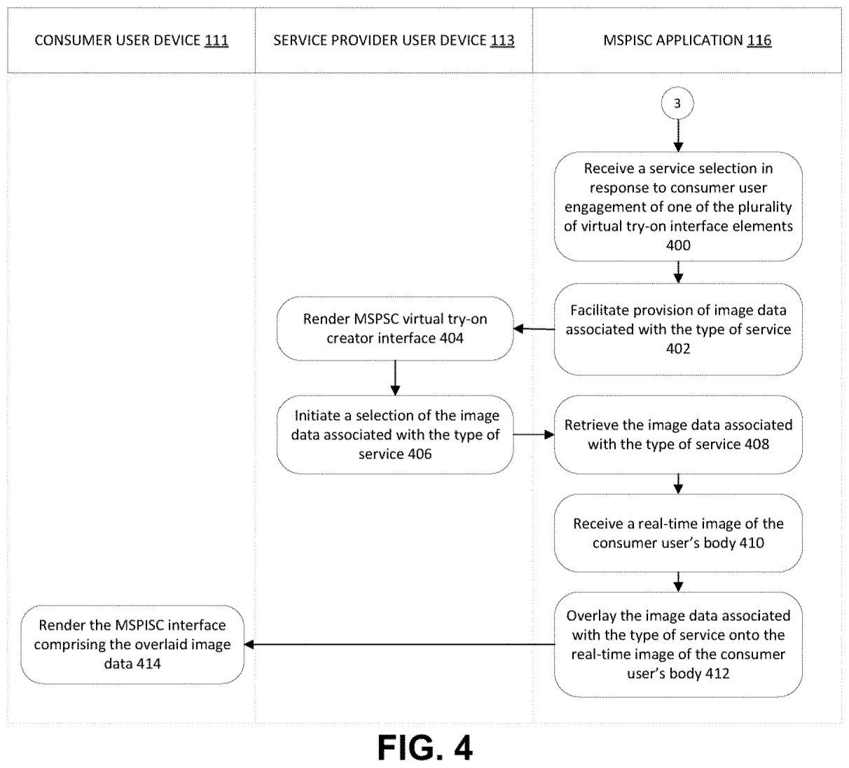

FIG. 4 illustrates the subsequent operations for outputting or updating a MSPISC interface comprising a plurality of services in response to the dynamic service request, the operations proceeding to follow FIG. 3 in reference to connector 3. In an example embodiment, the MSPISC interface comprises a plurality of services or service elements that are engageable by the consumer user via the computer interface of the consumer user device. For example, the MSPISC interface includes interactive interface icons or buttons as selection elements that are engageable by the consumer to select one or more virtual try-on interface elements. As used herein, the virtual try-on interface element is configured to depict a transformation to the consumer user's body according to the type of service.

Prior to step 400, the consumer user device 111 generates and transmits to the MSPISC application 116 a virtual try-on interface selection associated with a particular service based on consumer user engagement with the MSPISC interface (i.e., a consumer user selection of one of the plurality of virtual try-on interface elements associated with the plurality of services via the user interface of the consumer user device).

As follows and as seen in step 400, the MSPISC application 116 receives the service selection in response to the consumer user engagement of one of the plurality of virtual try-on interface elements. In step 402, the MSPISC application 116 facilitates provision of image data associated with the type of service. In step 404, the service provider user device 113 is configured to render the MSPISC virtual try-on creator interface. In some embodiments, the MSPISC virtual try-on creator interface allows the service provider to design an image, content, look (e.g., tattoo image, makeup look, nail design, etc.) by selecting image data associated with the type of service. In this way, the image, content, or look is shared with the consumer user such that the consumer user can try on such image, content, look contained with the service.

In step 406, the service provider user device 113 is configured to, using the MSPISC virtual try-on creator interface, initiate a selection of the image data (e.g., tattoo image, makeup image, nail design image, etc.) associated with the type of service. In response to the selection and as shown in step 408, the MSPISC application 116 retrieves the image data associated with the type of service. In addition, the format of the image data needs to be either pre-configured or adjusted to fit the body of the consumer user. The MSPISC application 116 addresses this by receiving a real-time image of the consumer user's body as shown in step 410. In step 412, the MSPISC application 116 is configured to overlay the image data associated with the type of service onto the real-time image of the consumer user's body. In step 414, the consumer user device 111 renders the MSPISC interface comprising the overlaid image data.

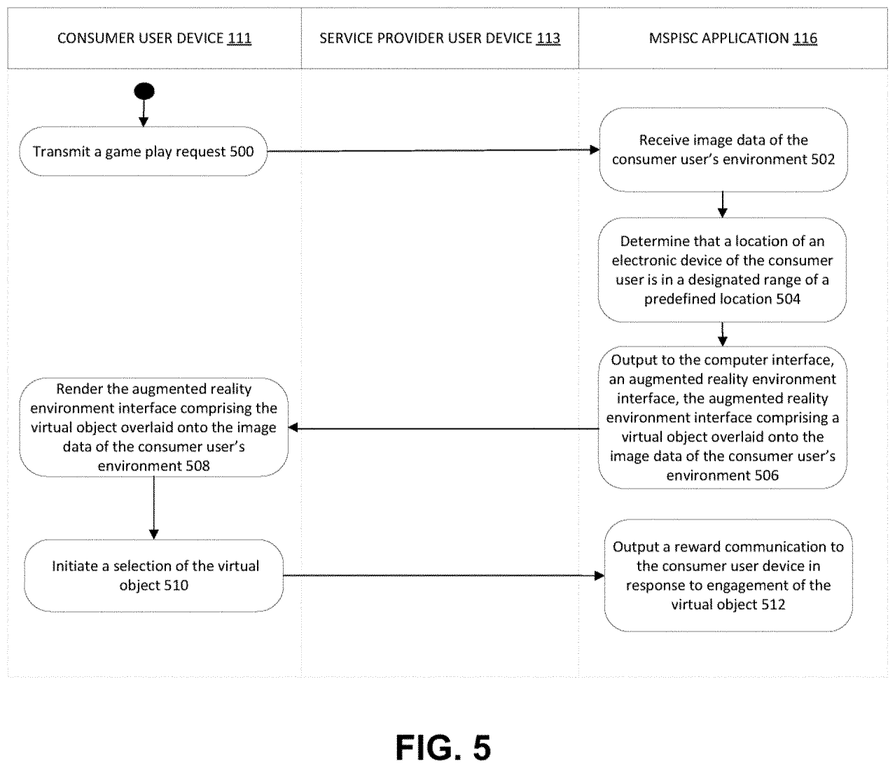

Referring now to FIG. 5, the process illustrates example operations performed by a MSPISC application 116 for providing an interactive, location-based augmented reality “scavenger hunt” game and a method of playing the interactive, location-based augmented reality “scavenger hunt” game. In some embodiments, the consumer user is provided with one or more clues directing them to a predetermined physical location (e.g., living room, park, building, in front of a specific landmark, etc.). When the consumer determines the location based on the one or more clues and is thus present at the predetermined location, the MSPISC application 116 is then configured to output, to the consumer user device, an augmented reality environment interface comprising a virtual object overlaid onto the image data of the consumer user's environment. The virtual object representative of a “treasure” or “reward” icon/image displayed as a superimposed element over the real-world view in the augmented reality environment interface on the consumer user device. Upon engaging with (e.g., selecting or accessing) the virtual object, the consumer user is awarded with a voucher, promotion, or value item for purchase of a service or physical item.

The process illustrated in FIG. 5 starts at step 500, where a consumer user device, for example consumer user device 111, transmits a game play request to the MSPISC application 116. In response to receiving the game play request, the MSPISC application 116 receives or retrieves image data of the consumer user's environment as shown in step 502. In some embodiments, the consumer user device 111 includes a camera configured to scan a user environment for image tags. Accordingly, MSPISC application 116 may identify image tags that are associated with a particular location (e.g., sofa, bed, windows, trees, picnic tables, a street sign, etc.). The MSPISC application 116 may then as shown in step 504, determine that a location of an electronic device of the consumer user (e.g., consumer user device 111) is in a designated range of a predefined location by identifying image tags that satisfy a location. Additionally or alternatively, the MSPISC application 116 may determine that the consumer user device 111 is in a designated range of a predefined location based on the location of the consumer user device based on one or more of an Internet Protocol (IP) address, a Message Authentication Code (MAC) address, radio-frequency identification (RFID), Wi-Fi connection location, or by some other means. The MSPISC application 116 may determine the consumer user device using a set of universal coordinates, such as latitude and longitude.

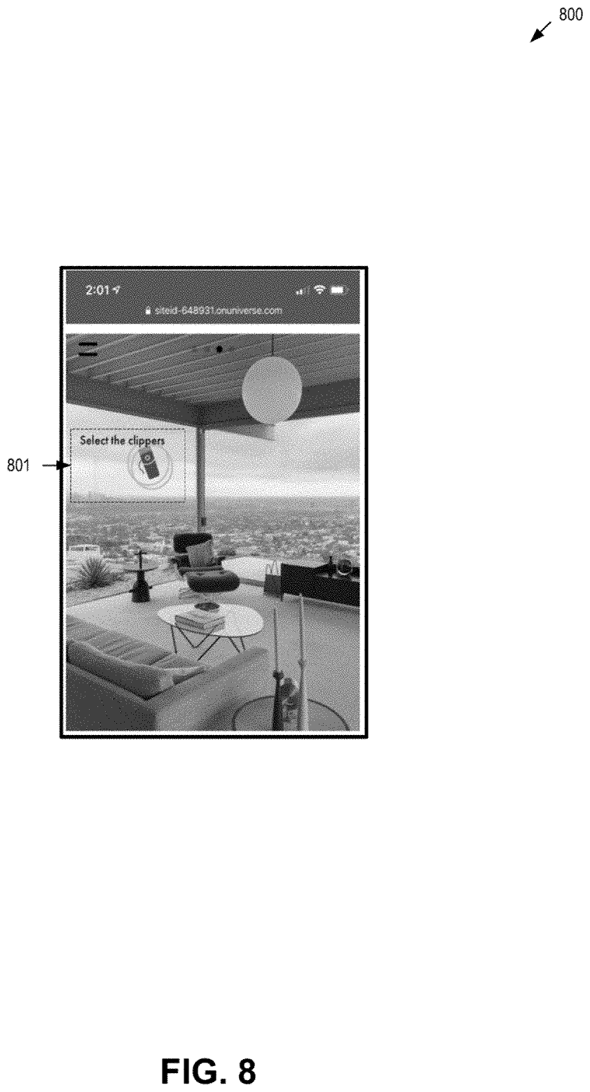

In step 506, the MSPISC application 116 outputs, to a computer interface of the consumer user device, an augmented reality environment interface, the augmented reality interface comprising a virtual object overlaid onto the image of the consumer user's environment. In step 508, the consumer user device 111 is configured to render the augmented reality environment interface comprising the virtual object overlaid onto the image data of the consumer user's environment. For example, the virtual object may be a coupon or a good displayed as a superimposed image over the consumer user's environment (e.g., real world view) in the augmented reality environment interface on the consumer user device. When the consumer user is located at the predefined location and the consumer user finds the virtual object, the consumer user is instructed to select or access the virtual object. In step 510, the consumer user device 111 is configured to initiate a selection of the virtual object 510. For example, FIG. 8 depicts a virtual object element 801 with instructions to select the virtual object 801.

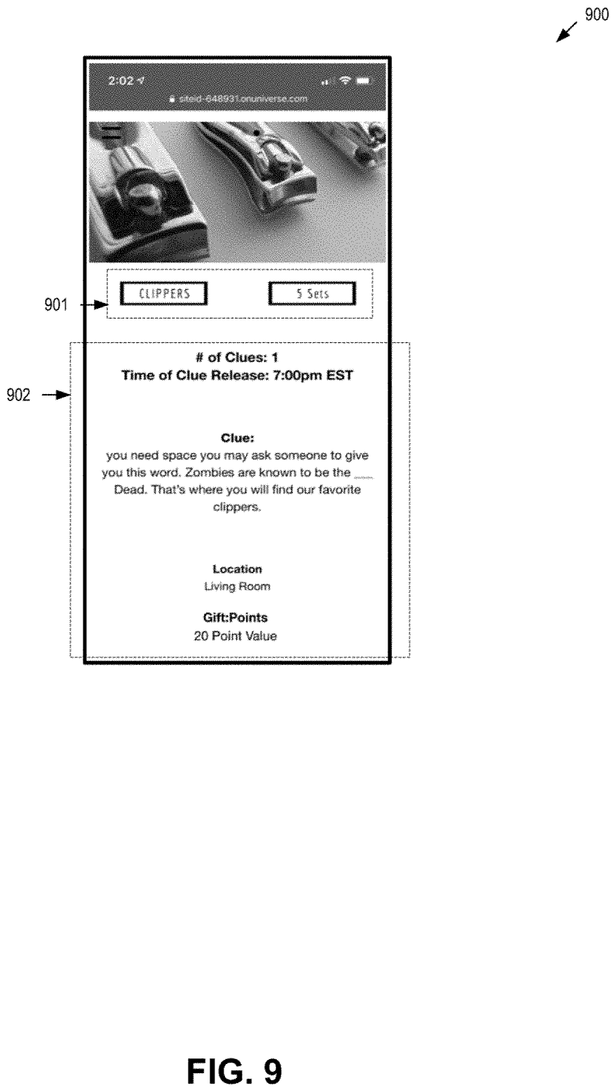

Returning to FIG. 5, in step 512, the MSPISC application 116 outputs a reward communication to the consumer user device in response to engagement of the virtual object. For example, as shown in FIG. 9, display 900 shows a reward communication comprising a reward description 901 and details of the scavenger hunt game 902 and reward (e.g., 20 Point Gift Value).

### Exemplary Graphical User Interfaces

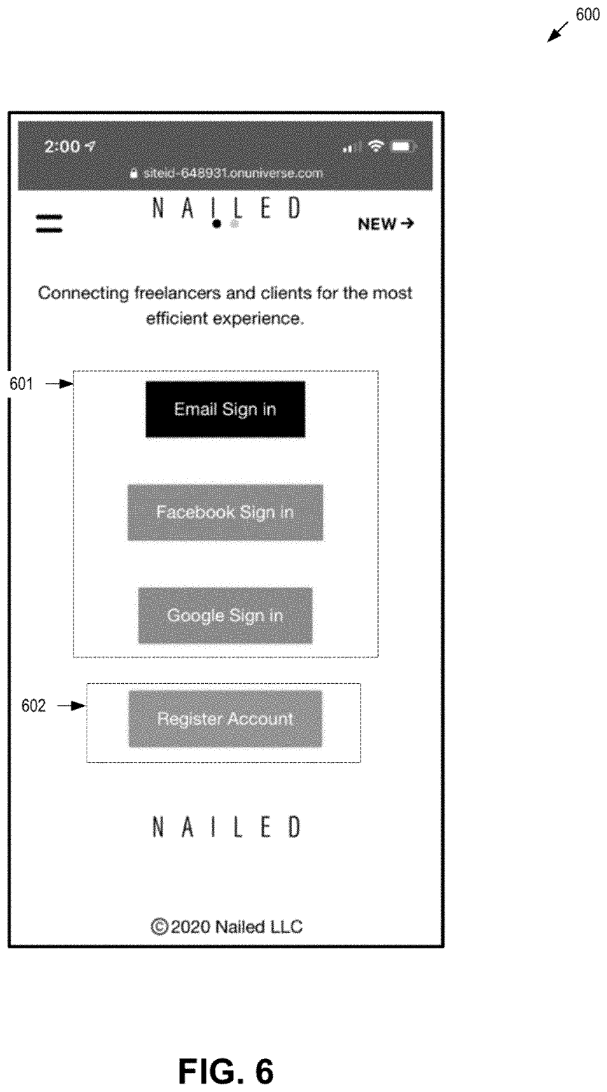

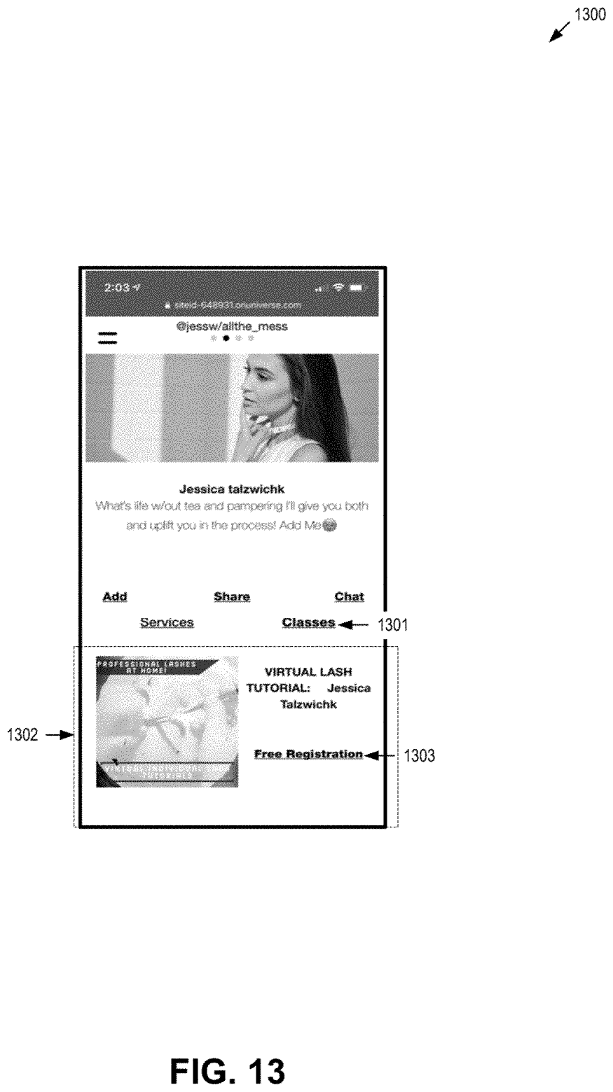

FIGS. 6-16 show example graphical user interfaces that may be presented by one or more display screens of one or more computing devices for implementing an example configuration according to various embodiments. For example, the graphical user interfaces of FIGS. 6-16 can be presented to a consumer user by a consumer user device or a service provider user by a service provider user device. The depicted graphical user interfaces are configured to enable the sale of services and to connect consumers to service providers through an interactive application for use by portable computing devices.

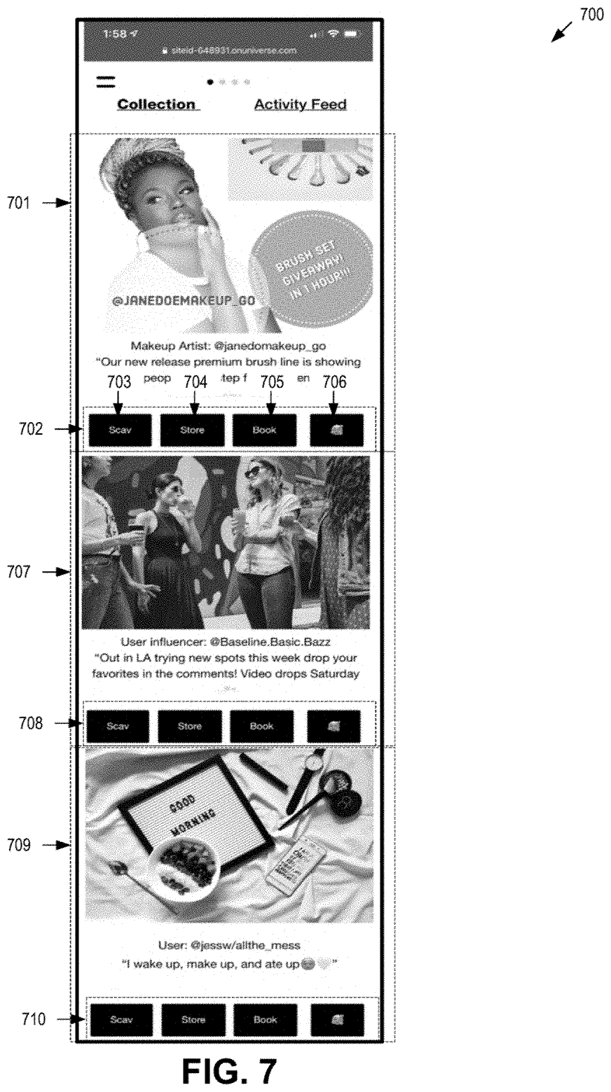

FIG. 6, for example, illustrates a MSPISC consumer user or service provider account selection interface 600. The MSPISC consumer user or service provider account selection interface provides a plurality of login options as shown by 601 and a method to register a consumer user or service provider account as shown by 602. A consumer user or service provider may login as a particular account and when logged in as a particular account, the consumer user or service provider accesses custom interactive interfaces as shown in FIGS. 7-16.

### A. Consumer User Account Interfaces

FIG. 7 illustrates a consumer user interactive support interface returned by the MSPISC application. The consumer user interactive support interface includes a plurality of MSPISC consumer user interfaces. The plurality of MSPISC consumer user interfaces includes a consumer user collection interface 700 comprising a plurality of service provider elements 701, 707, and 709. According to at least one embodiment of the present disclosure, the MSPISC application is configured to provide the consumer user the ability to engage with one or more of the service provider elements 701, 707, or 709 via a respective service provider engagement menu as shown by 702, 708, and 710. Each of the service provider engagement menus 702, 708, and 710 include a scavenger hunt element 703 configured to initiate a scavenger hunt game according to the operational steps discussed with reference to FIG. 5. The service provider engagement menus 702, 708, and 710 also include a store element 704 configured to display the service provider storefront showcasing service and product offerings provided by the service provider. Additionally, service provider engagement menus 702, 708, and 710 include a booking element 705 configured to facilitate purchasing and scheduling a service provided by the service provider. Finally, service provider engagement menus 702, 708, and 710 may include a popularity counter element 706 which is summed up and added to a popularity indicator of the service provider.

When the MSPISC application receives a game play request via the scavenger hunt element 703, the MSPISC application may then output, to a computer interface, the MSPISC interface comprising an augmented reality environment interface 800 as shown by FIG. 8. In FIG. 8, the augmented reality environment interface 800 comprises a virtual object 801 overlaid onto the image data of the consumer user's environment. In an example embodiment, the MSPISC application is configured to output a reward communication as shown by interface 900 of FIG. 9 to the electronic device of the consumer in response to engagement of the virtual object.

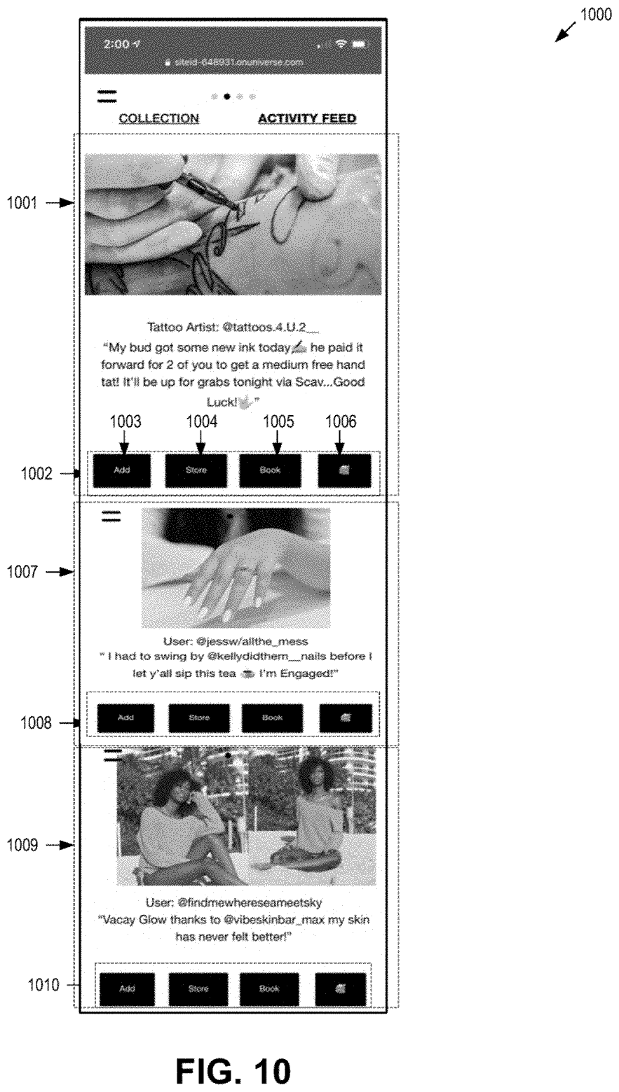

FIG. 10 shows another MSPISC consumer user interface comprising a consumer user activity feed interface 1000 comprising a plurality of service provider elements 1001, 1007, and 1009. In this case, the plurality of service provider elements 1001, 1007, and 1009 are identified and displayed by the consumer user activity feed interface 1000 based on the consumer user account identifier and consumer user data. In some embodiments, the MSPISC application is configured to query the database 117 for the consumer user data, using, e.g., the consumer user account identifier. The MSPISC application may generate a customized, recommended listing of service providers based at least in part on the consumer user data stored in the database 117. In at least one example embodiment, the MSPISC application may implement a heuristic that considers the consumer user's preferences captured via a graphical user interface questionnaire that is configured to obtain consumer user preferences. The heuristic includes a map table utilized by the MSPISC application to lookup a mapping of a consumer user preference to particular services and/or service provider types. In some embodiments, the map table may map services to consumer interests based on styles and/or features of the service; services offered by the service providers; whether other consumers with similar interests have purchased the service and/or engaged with the service provider; or the popularity indicator rankings associated with service providers. Thus, the MSPISC application using heuristics may determine whether a service provider or service is particularly suited to a consumer, and if so, generate at least one service recommendation and/or add at least one service provider to a recommended listing for display via the consumer user activity feed interface 1000 based on at least the obtained consumer user preferences.

According to at least one embodiment of the present disclosure, the MSPISC application is configured to provide the consumer user the ability to engage with one or more of the service provider elements 1001, 1007, and 1009 via a respective service provider engagement menu as shown by 1002, 1008, and 1010. Each of the service provider engagement menus 1002, 1008, and 1010 include an add service provider element 1003 configured to add the service provider to their saved collection of service providers for later retrieval via the consumer user collection interface 700. The service provider engagement menus 1002, 1008, and 1010 also include a store element 1004 configured to display the service provider storefront showcasing the service and product offerings provided by the service provider. Additionally, service provider engagement menus 1002, 1008, and 1010 include a booking element 1005 configured to facilitate purchasing and scheduling a service provided by the service provider. Finally, service provider engagement menus 1002, 1008, and 1010 may include a popularity counter element 1006 which is summed up and added to a popularity indicator of the service provider.

When the MSPISC application receives a request to review the service provider's store via the store element 1004, the MSPISC application may then output, to a computer interface, the MSPISC interface comprising a service provider storefront interface 1100 as shown by FIG. 11. In FIG. 11, the service provider storefront interface 1100 comprises a description or overview of the service provider as shown by 1101 and a service provider engagement menu 1102 which include an add service provider element 1103 configured to add the service provider to their saved collection of service providers for later retrieval via the consumer user collection interface 700. The service provider engagement menu 1002 also includes a share element 1104 configured to share the service provider via a web page Uniform Resource Locator (URL) on the consumer user's social networks or through digital communications (e.g., a text, email). Lastly, the service provider engagement menu 1002 may include a chat element 1105 configured to provide chat functionalities for a consumer user and the service provider.

The service provider storefront interface 1100 of FIG. 11 may also include a service provider service offerings interface 1106 comprising a plurality of services 1107-1113. Each of the services 1107-1113 identifies a type of service (e.g., eyebrow threading, lash extension, eyebrow wax, microblading), a price of the service 1114, a regional average price of the service 1115, and a virtual try-on interface element 1116, wherein the virtual try-on interface element is configured to depict a transformation to the consumer user's body according to the type of service.

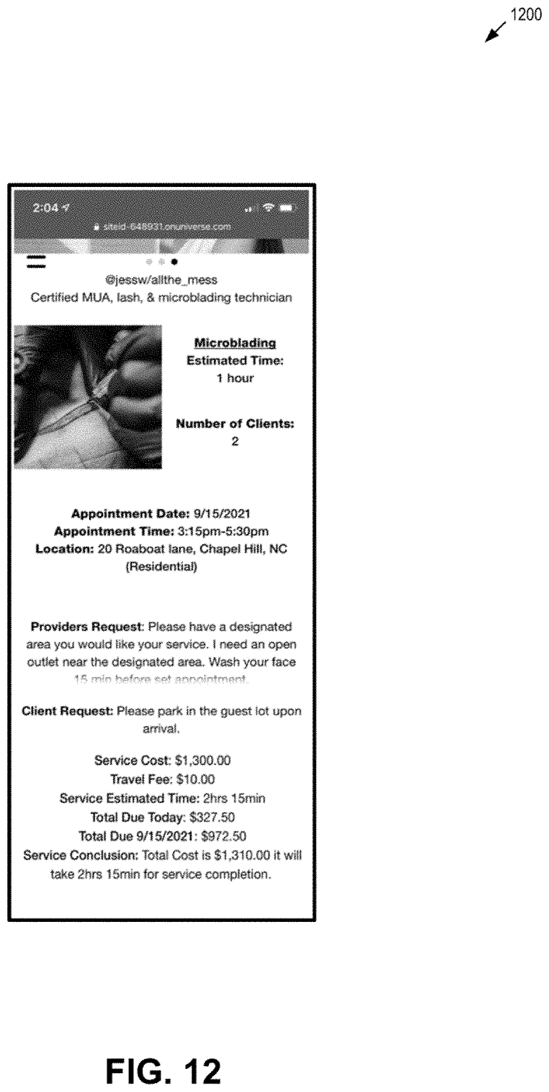

When the MSPISC application receives a request to review more details about a particular service, the MSPISC application may then output, to a computer interface, the MSPISC interface comprising a service details interface 1200 as shown by FIG. 12. In FIG. 12, the service details interface 1200 comprises a description or overview of the service which may include the following information: an estimated duration of the time required by the service provider to provide the service; the number of available appointments/clients; service appointment date and time; service appointment location; any service provider client requests; service cost; applicable travel fee; an estimate duration of the total time including travel required by the service provider to provide the service; any upfront costs/reservation costs; total costs including travel fees; and a summary/conclusion of the service.

The service provider storefront interface 1100 of FIG. 11 may also include a service provider service class offerings interface 1300 comprising one or more classes 1302. For example, a class description element 1302 describes the class and includes a registration element 1303, wherein the registration element is configured to register the consumer user for the class.

In some embodiments, the MSPISC application facilitates the execution of scheduling actions executed by the MSPISC system. Scheduling actions may include, without limitation, generation for display a prompt requesting confirmation from the consumer user that the service provider user completed the service at the given completion time in response to the service provider triggering completion of the service at the given completion time. Another scheduling action may include determining an estimated time of arrival of the service provider user at a service appointment location. The estimated time of arrival being based upon a location and velocity of an electronic device associated with the service provider user. Thereafter, a scheduling action may include updating a service provider tracking element to display the estimated time of arrival of the service provider user at the service appointment location.

In some embodiments, the MSPISC application may provide a promotion (such as reward points, discount points, and/or the like) to a consumer user in return for purchasing goods or services from particular service providers (such as recommended service providers). Such promotions may provide a discounted price for the current purchase or future purchases. Data related to the promotion such as the promotional content, promotional value, promotional conditions that when satisfied cause the promotion to be generated, and/or the like is stored within database 117. The promotion data stored in database 117 may be configured by the service provider via a MSPISC service provider user interface. In some embodiments, the MSPISC application may provide at checkout the promotion for display on the consumer user device when the promotional conditions are satisfied by a consumer user.

### B. Service Provider User Account Interfaces

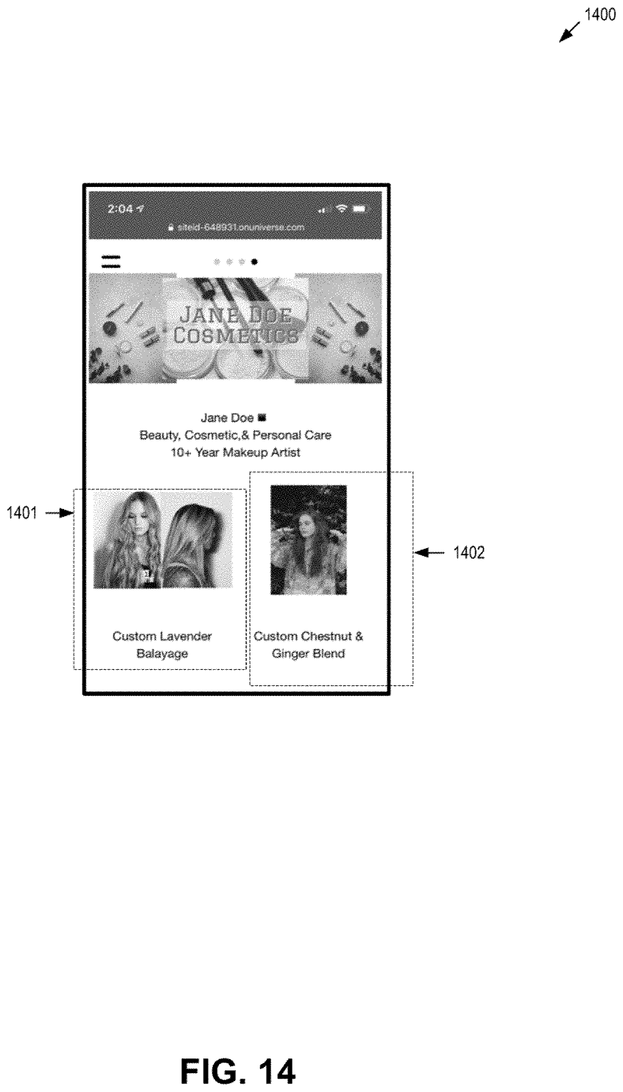

FIG. 14 illustrates a service provider user interactive support interface returned by the MSPISC application. The service provider user interactive support interface includes a plurality of MSPISC service provider user interfaces. The plurality of MSPISC service provider user interfaces includes a service provider storefront creation interface 1400 comprising a plurality of configurable service elements 1401 and 1402 which is editable by the service provider. The service provider storefront creation interface 1400 is further configured to enable service provider users to create, update, manipulate their services page layout that is viewable by consumer users. In some embodiments, the service provider storefront creation interface 1400 utilizes digital media (e.g., photos, videos, audio-videos, pictures, and/or text) to create service elements 1401 and 1402.

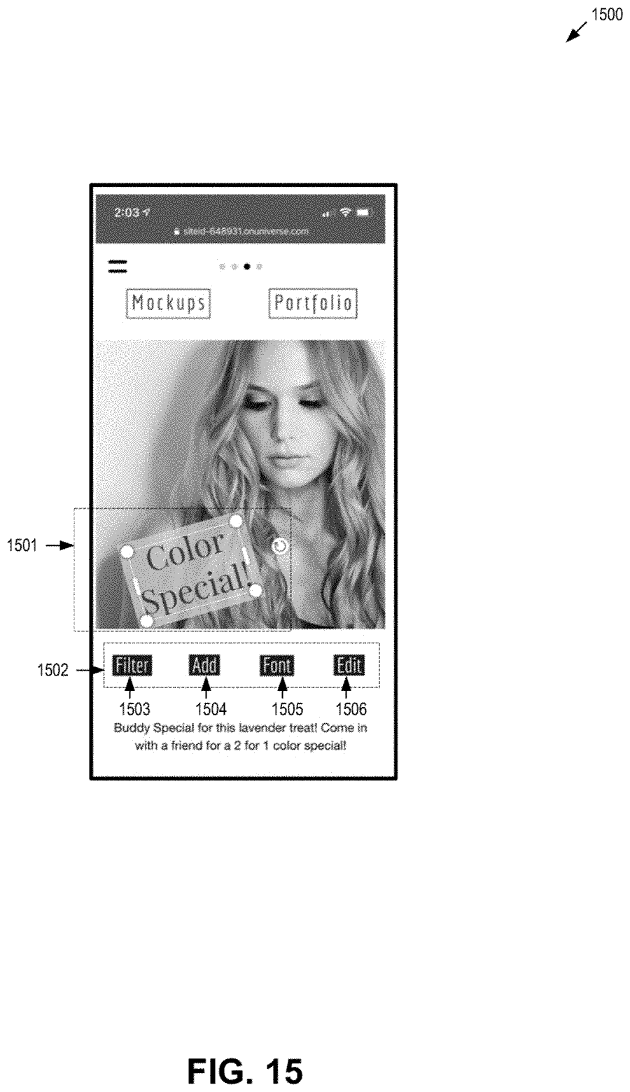

FIG. 15 is a screenshot embodiment of interface 1500 showing an insertion of text 1501 to describe a service offered by a service provider. In this example, text can be inserted to describe an image of a hair service. The interface 1500 comprises a creation menu element 1502 comprising a plurality of creation elements. In an example embodiment, when the service provider selects a filter creation element 1503, the MSPISC application provides the service provider user means for selecting image data used for the virtual try-on interface element as described in FIG. 4. Another creation element includes an add content element 1504 configured to provide the service provider user means for adding digital media (e.g., photos, videos, audio-videos, pictures, and/or text). The creation menu element 1502 also includes a font element 1505 configured to enable the service provider user means for manipulating a font style, a font size, a font color of text 1501. The creation menu element 1502 further includes an edit element 1506 to enable the service provider user means for manipulating images or media, such as for editing the color tone, texture, and the like of an image of the hair service as displayed by interface 1500.

### C. Multi-Service Provider Convention Interface Element

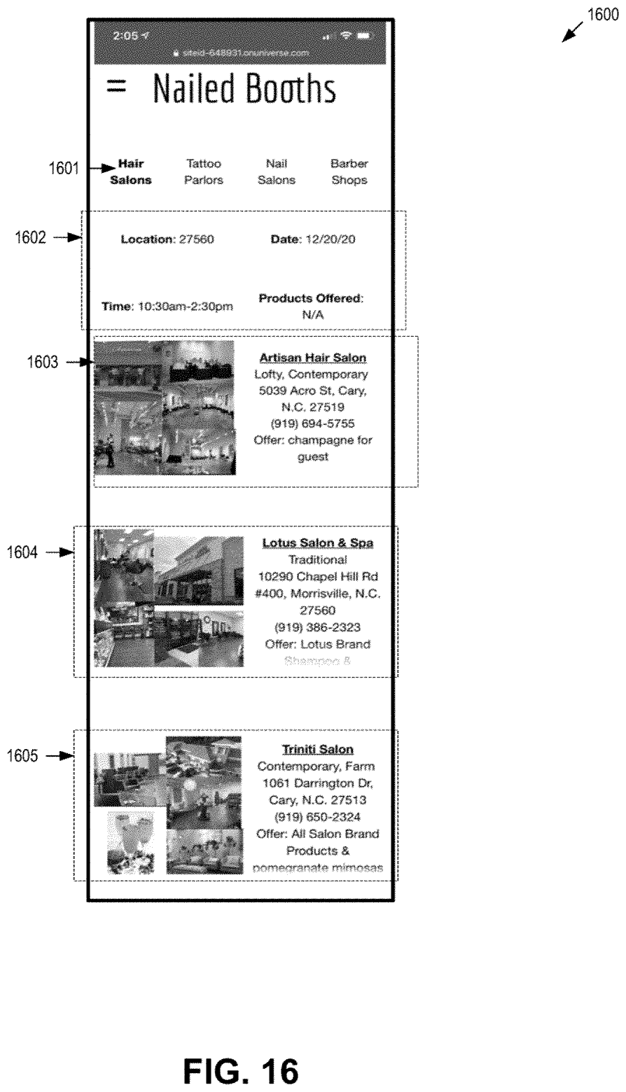

An illustration of at least one advantageous embodiment of the MSPISC application is illustrated in FIG. 16. FIG. 16 includes a convention/trade show booth interface 1600 provided for the use of consumer users to search for and identify services and products offered by exhibiting service providers. For example, the convention/trade show booth interface 1600 includes a listing of service providers by type (e.g., Hair Salons 1601), and a description 1602 of the convention including the location, date, and time. In an example embodiment, the consumer user may access a particular listing of hair service providers via selection of element 1601 of the convention/trade show booth interface 1600. The convention/trade show booth interface 1600 illustrates that selection of hair service providers comprises a plurality of hair salons, spas, and the like (See display elements 1603, 1604, and 1605).

In another example embodiment, the convention/trade show booth interface is provided for use by service provider users to rent and schedule trade show booths. Service provider users access the convention/trade show booth interface to view and search trade show booths available for rent by location, date/time, availability, and/or the like. In an example embodiment, the service provider may select for reservation a trade show booth via the convention/trade show booth interface. The MSPISC application may provide the service provider booth location services to help provide searches of booths near the location of the service provider or a specified location set by the service provider via the convention/trade show booth interface. In another example embodiment, the MSPISC application may automatically generate a recommended booth reservation. For example, the MSPISC application may search the database 117 comprising booth reservation data based on availability and one or more attributes such as location or type of service. The service provider user may then accept the recommended booth reservation.

In some embodiments, the MSPISC application receives a booth reservation request comprising a service provider account identifier and booth reservation data. The booth reservation data includes reservation information details such as booth identifier, booth location, date/time, and fees associated with renting the booth. In some embodiments, the service provider may pay the fees directly through the MSPISC application using payment networks, such as Visa, Mastercard, PayPal, etc. to process various types of payment transactions. In some embodiments, prior to payment, the MSPISC application generates a booth rental contract for the service provider user to electronically sign. The convention/trade show booth interface may allow the service provider user to request changes to the contract, such as pricing for the booth during the specified time period. In some embodiments, the MSPISC application may create a promotion (such as a discount and/or the like) for use when reserving booths to be offered to service provider users with a paid subscription to the MSPISC application.

### C. Other Multi-Service Provider Features

In some embodiments, the MSPISC application may include a virtual economy, in-app purchase options, or both. For example, in-app purchases may comprise an application feature, component, functionality, service, and/or the like that a service provider user or a consumer user may unlock or download in exchange for currency payment and/or promotion. For example, a service provider user may pay a fee to unlock enhanced editing tools provided by interface 1500. In return, the MSPISC application may provide a promotion (such as reward points, discount points, and/or the like) for use when reserving booths or acquiring said in-app purchases. For example, a promotion may provide a discounted price for renting a booth at a specified period of time.

In another example embodiment, the MSPISC application may include class hosting capabilities. In this case, the MSPISC application manages live and/or prerecorded video content provided by the service provider, which can be accessed by one or more consumer users. The MSPISC application may allow a service provider user to create and schedule live and/or prerecorded classes via a MSPISC service provider user interface.

In yet another example embodiment, the MSPISC application may provide e-commerce shopping where consumer users may browse an online catalog of products and/or services provided by the service provider, purchase such produces, as well as track aspects of the product shipment and delivery. The MSPISC application may allow a service provider user to create such a catalog and add/remove/edit offered products and/or services via a MSPISC service provider user interface.

In some embodiments, the MSPISC application may provide a mileage tracking service provider user interface to track mileage data that is needed to file an expense report for mileage deductions/expenses. The mileage tracking service provider user interface may allow the service provider to enter information such as start location, start time, arrival location, arrival time, and/or mileage/distance travelled. In some embodiments, the MSPSC application may automatically populate said information based on location data of the service provider user device provided by a GPS device on the service provider user device. In some embodiments, when certain information (such as arrival time) is entered by the service provider user, this may result in generation of a prompt for display to the consumer user requesting confirmation from the consumer user that the service provider indeed arrived at the service appointment location at the arrival time. The MSPSC application may generate alerts to be displayed by the consumer user device and service provider user device with information related to arrival time and current location. For example, an alert message may include information that the service provider will arrive at the appointment location in 5-8 minutes or that the service provider is delayed due to traffic and will arrive at the appointment location in 10-12 minutes.

### Exemplary Processes for Providing Connections Between Service Providers and Consumers

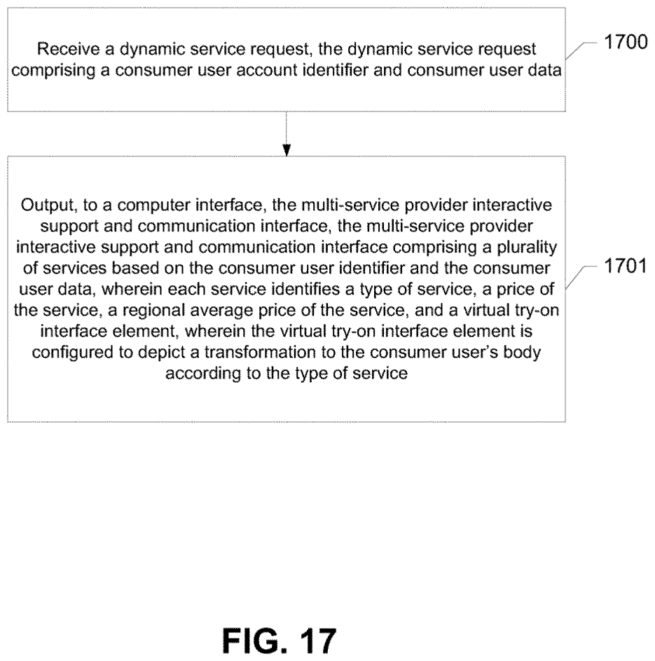

FIG. 17 shows an exemplary flowchart that embodies a computer implemented method for outputting, to a computer interface, the MSPISC interface. The computer implemented method begins with step 1700, where the MSPISC application receives a dynamic service request, the dynamic service request comprising a consumer user account identifier and consumer user data.

For example, a consumer user logs-in, registers, or establishes a connection to the MSPISC application. Once a connection to the MSPISC application has been established, the MSPISC application may transmit data comprising a consumer user account identifier and consumer user data associated with the consumer user to the MSPISC application.

As shown in step 1701, the MSPISC application is then configured to output, to a computer interface, the multi-service provider interactive support and communication interface, the multi-service provider interactive support and communication interface comprising a plurality of services based on the consumer user identifier and the consumer user data, wherein each service identifies a type of service, a price of the service, a regional average price of the service, and a virtual try-on interface element, wherein the virtual try-on interface element is configured to depict a transformation to the consumer user's body according to the type of service. According to an example embodiment, the MSPISC application receives a real-time image of the consumer user's body and image data associated with the type of service. The MSPISC application is then configured to overlay, via the virtual try-on interface, the image data associated with the type of service onto the real-time image of the consumer user's body.

Embodiments of the present invention have been described above with reference to block diagrams and flowchart illustrations of methods, apparatuses, systems and computer program products. It will be understood that each block of the circuit diagrams and process flowcharts, and combinations of blocks in the circuit diagrams and process flowcharts, respectively, can be implemented by various means including computer program instructions. These computer program instructions may be loaded onto a general-purpose computer, special purpose computer, or other programmable data processing apparatus, such as processor 210 and/or MSPISC application logic 224 as discussed above, to produce a machine, such that the computer program product includes the instructions which execute on the computer or other programmable data processing apparatus create a means for implementing the functions specified in the flowchart block or blocks.

These computer program instructions may also be stored in a computer-readable storage device (e.g., the memory 212) that can direct a computer or other programmable data processing apparatus to function in a particular manner, such that the instructions stored in the computer-readable storage device produce an article of manufacture including computer-readable instructions for implementing the function discussed herein. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions discussed herein.

Accordingly, blocks of the block diagrams and flowchart illustrations support combinations of means for performing the specified functions, combinations of steps for performing the specified functions and program instruction means for performing the specified functions. It will also be understood that each block of the circuit diagrams and process flowcharts, and combinations of blocks in the circuit diagrams and process flowcharts, can be implemented by special purpose hardware-based computer systems that perform the specified functions or steps, or combinations of special purpose hardware and computer instructions.

Many modifications and other embodiments of the inventions set forth herein will come to mind to one skilled in the art to which these embodiments of the invention pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. An apparatus for operating a multi-service provider interactive support and communication interface of a multi-service provider interactive support and communication system, the apparatus comprising at least one processor, and at least one memory having computer coded instructions therein, with the computer instructions configured to, when executed by the processor, cause the apparatus to:
receive a dynamic service request, the dynamic service request comprising a consumer user account identifier and consumer user data; and
output, to a computer interface, the multi-service provider interactive support and communication interface, the multi-service provider interactive support and communication interface comprising a plurality of services based on the consumer user identifier and the consumer user data, wherein each service identifies a type of service, a price of the service, a regional average price of the service, and a virtual try-on interface element, wherein the virtual try-on interface element is configured to depict a transformation to the consumer user's body according to the type of service.

2. The apparatus of claim 1, wherein depicting the transformation to the consumer user's body according to the type of service causes the at least one memory and the computer instructions to, when executed by the processor, cause the apparatus to further:
receive a real-time image of the consumer user's body and image data associated with the type of service; and
overlay, via the virtual try-on interface, the image data associated with the type of service onto the real-time image of the consumer user's body.

3. The apparatus of claim 1, wherein the multi-service provider interactive support and communication interface is configured, when engaged by the service provider user to trigger execution of the service, to generate for display a confirmation notifying the consumer user of the start of the service; and
wherein the multi-service provider interactive support and communication interface is configured, when engaged by the service provider user to trigger completion of the service at a given completion time, to generate for display a prompt requesting confirmation from the consumer user that the service provider user completed the service at the given completion time.

4. The apparatus of claim 1, wherein the multi-service provider interactive support and communication interface comprises a service provider tracking element, and wherein the at least one memory and the computer instructions are configured to, when executed by the processor, cause the apparatus to further:
determine an estimated time of arrival of the service provider user at a service appointment location, the estimated time of arrival being based upon a location and velocity of an electronic device associated with the service provider user; and
update the service provider tracking element to display the estimated time of arrival of the service provider user at the service appointment location.

5. The apparatus of claim 1, wherein the at least one memory and the computer instructions are configured to, when executed by the processor, cause the apparatus to further:
output, to the computer interface, a graphical user interface questionnaire that is configured to obtain consumer user preferences; and
generate at least one service recommendation based on at least the obtained consumer user preferences.

6. The apparatus of claim 1, wherein the at least one memory and the computer instructions are configured to, when executed by the processor, cause the apparatus to further:
receive image data of the consumer user's environment;
determine that a location of an electronic device of the consumer user is in a designated range of a predefined location;
responsive to the determination, output to the computer interface, an augmented reality environment interface, the augmented reality environment interface comprising a virtual object overlaid onto the image data of the consumer user's environment; and
output a reward communication to the electronic device of the consumer in response to engagement of the virtual object.

7. A method for operating a multi-service provider interactive support and communication interface of a multi-service provider interactive support and communication system, the method comprising:
receiving a dynamic service request, the dynamic service request comprising a consumer user account identifier and consumer user data; and
outputting, to a computer interface, the multi-service provider interactive support and communication interface, the multi-service provider interactive support and communication interface comprising a plurality of services based on the consumer user identifier and the consumer user data, wherein each service identifies a type of service, a price of the service, a regional average price of the service, and a virtual try-on interface element, wherein the virtual try-on interface element is configured to depict a transformation to the consumer user's body according to the type of service.

8. The method of claim 7, wherein depicting the transformation to the consumer user's body according to the type of service further comprises:
receiving a real-time image of the consumer user's body and image data associated with the type of service; and
overlaying, via the virtual try-on interface, the image data associated with the type of service onto the real-time image of the consumer user's body.

9. The method of claim 7, wherein the multi-service provider interactive support and communication interface is configured, when engaged by the service provider user to trigger execution of the service, to generate for display a confirmation notifying the consumer user of the start of the service; and
wherein the multi-service provider interactive support and communication interface is configured, when engaged by the service provider user to trigger completion of the service at a given completion time, to generate for display a prompt requesting confirmation from the consumer user that the service provider user completed the service at the given completion time.

10. The method of claim 7, wherein the multi-service provider interactive support and communication interface comprises a service provider tracking element further comprising:
determining an estimated time of arrival of the service provider user at a service appointment location, the estimated time of arrival being based upon a location and velocity of an electronic device associated with the service provider user; and
updating the service provider tracking element to display the estimated time of arrival of the service provider user at the service appointment location.

11. The method of claim 7, further comprising:
outputting, to the computer interface, a graphical user interface questionnaire that is configured to obtain consumer user preferences; and
generating at least one service recommendation based on at least the obtained consumer user preferences.

12. The method of claim 7, further comprising:
receiving image data of the consumer user's environment;
determining that a location of an electronic device of the consumer user is in a designated range of a predefined location;
responsive to the determination, outputting to the computer interface, an augmented reality environment interface, the augmented reality environment interface comprising a virtual object overlaid onto the image data of the consumer user's environment; and
outputting a reward communication to the electronic device of the consumer in response to engagement of the virtual object.

13. A computer program product for operating a multi-service provider interactive support and communication interface of a multi-service provider interactive support and communication system, the computer program product comprising at least one non-transitory computer-readable storage medium storing program instructions that, when executed, cause a computing system to:
receive a dynamic service request, the dynamic service request comprising a consumer user account identifier and consumer user data; and
output, to a computer interface, the multi-service provider interactive support and communication interface, the multi-service provider interactive support and communication interface comprising a plurality of services based on the consumer user identifier and the consumer user data, wherein each service identifies a type of service, a price of the service, a regional average price of the service, and a virtual try-on interface element, wherein the virtual try-on interface element is configured to depict a transformation to the consumer user's body according to the type of service.

14. The computer program product of claim 13, wherein depicting the transformation to the consumer user's body according to the type of service further causes the at least one non-transitory computer-readable storage medium to further store program instructions that, when executed, cause the computing system to:
receive a real-time image of the consumer user's body and image data associated with the type of service; and
overlay, via the virtual try-on interface, the image data associated with the type of service onto the real-time image of the consumer user's body.

15. The computer program product of claim 13, wherein the multi-service provider interactive support and communication interface is configured, when engaged by the service provider user to trigger execution of the service, to generate for display a confirmation notifying the consumer user of the start of the service; and
wherein the multi-service provider interactive support and communication interface is configured, when engaged by the service provider user to trigger completion of the service at a given completion time, to generate for display a prompt requesting confirmation from the consumer user that the service provider user completed the service at the given completion time.

16. The computer program product of claim 13, wherein the multi-service provider interactive support and communication interface comprises a service provider tracking element further causing the at least one non-transitory computer-readable storage medium to further store program instructions that, when executed, cause the computing system to:
determine an estimated time of arrival of the service provider user at a service appointment location, the estimated time of arrival being based upon a location and velocity of an electronic device associated with the service provider user; and
update the service provider tracking element to display the estimated time of arrival of the service provider user at the service appointment location.

17. The computer program product of claim 13, wherein the at least one non-transitory computer-readable storage medium further stores program instructions that, when executed, cause the computing system to:
output, to the computer interface, a graphical user interface questionnaire that is configured to obtain consumer user preferences; and
generate at least one service recommendation based on at least the obtained consumer user preferences.

18. The computer program product of claim 13, wherein the at least one non-transitory computer-readable storage medium further stores program instructions that, when executed, cause the computing system to:
receive image data of the consumer user's environment;
determine that a location of an electronic device of the consumer user is in a designated range of a predefined location;
responsive to the determination, output to the computer interface, an augmented reality environment interface, the augmented reality environment interface comprising a virtual object overlaid onto the image data of the consumer user's environment; and
output a reward communication to the electronic device of the consumer in response to engagement of the virtual object.
